(19) United States
(12) Patent Application Publication
(10) Pub. No.: US 2021/0117813 A1
(43) Pub. Date: Apr. 22, 2021

(54) METHOD AND SYSTEM FOR GENERATING HUMOROUS PERSONALITY INFORMATION FOR ROBOT BY USING KNOWLEDGE BASE

(71) Applicant: Jianjun ZHANG, Zhengzhou, Henan (CN)

(72) Inventors: Jianjun ZHANG, Zhengzhou, Henan (CN); Tingran ZHANG, Zhengzhou, Henan (CN)

(73) Assignee: Jianjun ZHANG, Zhengzhou, Henan (CN)

(21) Appl. No.: 16/965,308

(22) PCT Filed: Mar. 29, 2019
(86) PCT No.: PCT/CN2019/080348

§ 371 Date: Jul. 28, 2020

(30) Foreign Application Priority Data
Jul. 27, 2018 (CN) 201810843762.6

(51) Int. Cl. G06N 5/02; G06F 16/906; G06F 16/9035

(52) U.S. Cl. CPC G06N 5/022; G06F 16/9035; G06F 16/906; G06N 5/025

(57) ABSTRACT

Provided are a method and system for generating humorous personality information for a robot by using a knowledge base The method includes: performing grouping; establishing a group knowledge base using predictions of each group as an information classification criterion; determining a group type to which an audience belongs; establishing, from the group knowledge base, an audience knowledge base using an audience prediction as an information classification criterion; generating a piece of information or developing another piece of information from said piece of information; establishing a context knowledge base; changing one piece of information in the context knowledge base in a hypothetical manner; changing generated information or changing a development on the basis of the changed information in the context knowledge base; and displaying the changed generated information, hypothetical information, or the changed development. The tacit sharing of the double negation of rationality makes robot humorous.

The present application claims priority to Chinese Patent Application No. 201810843762.6, titled “METHOD AND SYSTEM FOR GENERATING HUMOROUS PERSONALITY INFORMATION FOR ROBOT BY USING KNOWLEDGE BASE”, filed on Jul. 27, 2018 with the China National Intellectual Property Administration (CNIPA), which is incorporated herein by reference in its entirety.

### FIELD

The present disclosure generally relates to the technical field of artificial intelligence, and in particular to a method and a system for generating humorous personality information of a robot based on a knowledge base.

### BACKGROUND

Humor makes people feel funny and happy and laugh, intertwined with cognitive, psychological, physical and social activities. Humor mainly has the following theories: superiority theory, relief theory, incongruity theory and benign violation theory. The superiority theory believes that humor comes from one's sense of superiority due to negative features of other people, such as abnormality, misfortune or shortcomings. The relief theory believes that humor comes from a sudden disappearance of an original psychological pressure. The incongruity theory believes that humor comes from contradiction, abnormality, incongruity or resolving of them. The benign violation theory believes that humor comes from a benign violation of a rule but not having a bad result. The superiority theory finds a psychological result of humor, the relief theory focuses on a psychological motivation of humor, and the incongruity theory finds incongruity and tries to resolving the incongruity.

In the conventional technology, one kind of method for generating humorous personality of a robot is to search and match a ready-made humor material from a human humor knowledge base, such as Microsoft's chatting robot Xiaobing. Another kind of method for generating humorous personality of a robot is based on a belief that humor comes from a sense of superiority, relief of pressure, benign violation, incongruity or resolving of incongruity, and mainly generates some word plays in a specific language, which has little humorous effect.

Therefore, how to effectively generate humorous personality information of a robot is a problem required to be solved.

### SUMMARY

In view of the above, based on nature of human humor and features of a robot, a method and system for generating humorous personality information of a robot based on a knowledge base are provided in the present disclosure, and can effectively generate humorous personality information of a robot compared with the conventional technology.

A method for generating humorous personality information of a robot based on a knowledge base is provided in the present disclosure. The method includes:

dividing groups;

establishing a group knowledge base with each group prediction as an information classification criterion;

determining a group type of an audience;

establishing, from the group knowledge base, an audience knowledge base with an audience prediction as an information classification criterion;

generating a piece of information or developing, from the piece of information to another piece of information;

establishing a context knowledge base;

changing one piece of information in the context knowledge base in a hypothetical manner, such that the generated information becomes in contradiction with a piece of information in the audience knowledge base, or a meaning of the generated information changes or a way of the developing changes;

changing the generated information or changing the way of developing based on the changed information in the context knowledge base; and

displaying the changed generated information, hypothetical information, or a changed development.

A system for generating humorous personality information of a robot based on a knowledge base is provided in the present disclosure. The system includes:

a dividing module, configured to divide groups;

a first establishing module, configured to establish a group knowledge base with each group prediction as an information classification criterion;

a determining module, configured to determine a group type of an audience;

a second establishing module, configured to establish, from the group knowledge base, an audience knowledge base with an audience prediction as an information classification criterion;

a generating module, configured to generate a piece of information or developing, from the piece of information to another piece of information;

a third establishing module, configured to establish a context knowledge base; and

a processing module, configured to change one piece of information in the context knowledge base in a hypothetical manner, such that the generated information becomes in contradiction with a piece of information in the audience knowledge base, a meaning of the generated information changes or a way of developing changes; and change the generated information or change the way of developing based on the changed information in the context knowledge base; and display the changed generated information, hypothetical information, or a changed development.

As can be seen from the above technical solution, a method and a system for generating humorous personality information of a robot based on a knowledge base are provided in the present disclosure. The method includes: dividing groups, establishing a group knowledge base, determining a group type of an audience, establishing an audience knowledge base, generating a piece of information or a development, establishing a context knowledge base, changing a context in a hypothetical manner, changing the generated information or the development, and finally displaying the changed generated information, hypothetical information, or a changed development. Compared with the conventional technology, the present disclosure can effectively generate humorous personality information of a robot, and is a negation on a negation of rationality, where the rationality is determined based on contradictionariness between the displayed information and the information in the audience knowledge base, such that an audience can experience, from confusion and nerves, to tacit understanding and sharing of a secret through common background knowledge, thereby feeling intellectual pride, a sense of identity, tacit understanding, relaxation, pleasure and amusement, and experiencing robot humor.

### BRIEF DESCRIPTION OF THE DRAWINGS

In order to more clearly describe the technical solutions in the embodiments of the present disclosure or the technical solutions in the conventional technology, drawings to be used in the description of the embodiments of the present disclosure or the conventional technology are briefly described hereinafter. It is apparent that the drawings described below show merely the embodiments of the present disclosure, and those skilled in the art may obtain other drawings according to the provided drawings without any creative effort.

FIG. 1 is a flowchart of a method for generating humorous personality information of a robot based on a knowledge base according to a first embodiment of the present disclosure;

and

FIG. 2 is a structural schematic diagram of a system for generating humorous personality information of a robot based on a knowledge base according to a first embodiment of the present disclosure.

### DETAILED DESCRIPTION OF EMBODIMENTS

Technical solutions of embodiments of the present disclosure are clearly and completely described below in conjunction with the drawings of the embodiments of the present disclosure. Apparently, the embodiments described in the following are only some embodiments of the present disclosure, rather than all the embodiments. Any other embodiments obtained by those skilled in the art based on the embodiments in the present disclosure without any creative effort fall within the protection scope of the present disclosure.

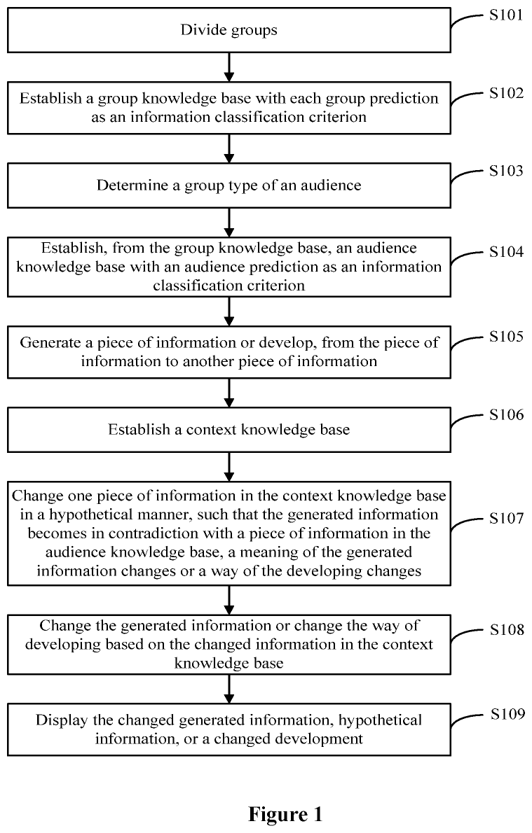

FIG. 1 is a flowchart of a method for generating humorous personality information of a robot based on a knowledge base according to a first embodiment of the present disclosure. As shown in FIG. 1, the method may include the following steps S101 to S109.

In step S101, groups are divided.

When it is required to generate humorous personality information of a robot based on a knowledge base, firstly groups are divided based on group features such as age, gender, education, profession, occupation, class, language, ethnicity, race, interest, hobby, belief, religion, region, country or culture as a criterion, such that the following steps are performed targeting an audience in a certain group.

Specifically, groups may be divided into “Chinese”, “American”, “Japanese” and the like based on nationality.

Specifically, groups may be divided into “doctor”, “teacher”, “farmer” and the like based on occupation.

In step S102, a group knowledge base is established with each group prediction as an information classification criterion.

The group knowledge base is established by using each group prediction as an information classification criterion, rather than using some key words contained in contents as a criterion. Prediction information refers to as information that a certain group is likely to know. Group prediction information forms a group knowledge unit, and a group knowledge unit forms a group knowledge base. A simple group knowledge base may only include one group knowledge unit, while a complex group knowledge base may include multiple group knowledge units. A group knowledge base including only one group knowledge unit is only directed to one group, and a group knowledge base including multiple group knowledge units may be directed to multiple groups. The group knowledge base provides an information source for an audience knowledge base.

For example, a group knowledge base including only one “Chinese” group knowledge unit can only make a Chinese feel humor of a robot. Information that a “Chinese” group is likely to know such as “Beijing is a city”, “Beijing is in the north of China”, “China has a long history”, “Vietnam is to the south of China” and “The Yangtze River is longer than the Yellow River” is organized together by using “Chinese” group predictions as a criterion, to establish a “Chinese” group knowledge unit, and thus establish a group knowledge base.

Specifically, a group knowledge base may simultaneously include a “Chinese” group knowledge unit, an “American” group knowledge unit, and a “German” group knowledge unit. A group knowledge base may also simultaneously include a “worker” group knowledge unit, a “farmer” group knowledge unit, a “lawyer” group knowledge unit, a “doctor” group knowledge unit and the like.

Specifically, information that a “junior school student” group is likely to know such as “addition, subtraction, multiplication and division operational rules” is organized together by using “junior school student” group predictions as a criterion, to establish a “junior school student” group knowledge unit.

Specifically, information that a “Chinese junior school student” group is likely to know is organized together by using “Chinese junior school student” predictions as a criterion to establish a “Chinese junior school student” group knowledge unit. The information that the “Chinese junior school student” group is likely to know simultaneously includes information that whole of a “Chinese” group is likely to know and information that whole of a “junior school student” group is likely to know, and information that a “junior school student” part of the “Chinese” group, which is a “Chinese” part of the “junior school student” group is likely to know, such as information of Chinese senior high school entrance examination.

Specifically, prediction information of a “Chinese male junior school student” group is organized together by using “Chinese male junior school student” predictions as a criterion to form a “Chinese male junior school student” group knowledge unit.

In step S103, a group type of an audience is determined.

A group type of an audience is determined by using audience features such as age, gender, education, country or profession of the audience as a criterion.

For example, it is determined that an audience belongs to the “Chinese” group.

For example, it is determined that an audience belongs to a “male” group, the “Chinese” group and the “junior school student” group.

In step S104, an audience knowledge base is established from the group knowledge base with an audience prediction as an information classification criterion.

The audience knowledge base is established from the group knowledge base by using the audience prediction as the information classification criterion. Prediction information refers to as information that an audience is likely to know.

Specifically, in a case that a group knowledge base includes a ready-made group knowledge unit for a group to which an audience belongs, information of an audience knowledge base directly uses the group knowledge unit for the group to which the audience belongs. For example, in a case that the group knowledge base includes a “Chinese junior school student” group knowledge unit, a “Chinese junior school student” audience knowledge base directly uses the “Chinese junior school student” group knowledge unit.

Specifically, in a case that a group knowledge base does not include a ready-made group knowledge unit for a group to which an audience belongs, an audience knowledge base of an audience having features that belong to an intersection set of features of multiple groups uses a union set of group knowledge units having these features. For example, a “Chinese football fan” is an audience having features that belong to an intersection set of features of a “Chinese” and features of a “football fan”. In a case that a group knowledge base includes a “Chinese” group knowledge unit and a “football fan” group knowledge unit but does not include a “Chinese football fan” group knowledge unit, a “Chinese football fan” audience knowledge base uses a union set of the “Chinese” group knowledge unit and the “football fan” group knowledge unit. More features of an audience, then more pieces of information in an audience knowledge base. If an audience has no features, information in the audience knowledge base only includes contents that all human being know.

Specifically, in a case that a group knowledge base does not include a ready-made group knowledge unit for a group to which an audience belongs, an audience knowledge base of an audience having features that belong to a union set of features of multiple groups uses an intersection set of group knowledge units having these features. For example, a “Chinese or football fan” audience has features that belong to a union set of features of a “Chinese” and features of a “football fan”. In a case that a group knowledge base includes a “Chinese” group knowledge unit and a “football fan” group knowledge unit but does not include a “Chinese or football fan” group knowledge unit, a “Chinese or football fan” audience knowledge base uses an intersection set of the “Chinese” group knowledge unit and the “football fan” group knowledge unit.

The audience knowledge base enables an audience and a robot to share information in a common context.

In step S105, a piece of information is generated or the piece of information is developed to another piece of information.

A piece of information (set as information A) is generated or the piece of information is developed to another piece of information (set as information B). The information may be in the form of a language or a character such as a word, a phrase and a sentence. The information may also be in a form of a tone, a face expression, a body action, a behavior, an event and the like, which are expressed in a form of language or character such as a word, a phrase and a sentence.

In a particular language, a same word, phrase or sentence may express different meanings in different contexts. A same word, phrase, sentence, tone, face expression, body action, behavior, event and the like may express different meanings in different contexts.

Specifically, a single word can express information. For example, a famous entertainer in Hong Kong is called as Guo-rong Cheung, Guo-rong, Leslie, young master Rong, elder brother, uncle Cheung, monkey Cheung and the like, which express different meanings.

For example, “He stood up suddenly” may express a shallow meaning, which refers to an act that a leg rapidly moves from bent to straight, and may also express a different deep meaning in a different context that the action may express anger, pleasure, excitement, impulsion, obedience, opposing, yielding, applauding, supporting, demonstrating, leaving, receiving an instruction or taking an action.

For example, “The weather is good today” expresses a physical state of the weather in a weather forecasting context, while mainly expresses kindness and goodwill in a social context.

In a case that the information A is developed to information B, the information A may be generated information or received information.

For example, in “I am a little hungry, I want to eat”, the former sentence is developed to the later sentence. Both the former sentence and the later sentence are newly generated information.

For example, in a dialogue “Does your house often leak rain?”, “No, it leaks only when it rains”, the former sentence is also developed to the later sentence. The former sentence may be information from somebody else.

In step S106, a context knowledge base is established.

Information searched from an audience knowledge base by using a word forming a sentence of the information A or the information B as a key word and information that an audience just received may serve as contents in the context knowledge base. Searched information including a key word closely related to information to be displayed in content, in time or in space or information that recently acquired by the audience is arranged in front to establish the context knowledge base. With the context knowledge base, the displayed information form has an exact meaning.

For example, when it is desired to establish a “Li Ming rides a horse on a grassland” context knowledge base, a search is performed on an audience knowledge base by using “Li Ming”, “grassland”, “ride” and “horse” as key words. Searched information about a horse, a large mammal, a mammal, an animal, and a living being is arranged in sequential order. Searched information about a horse in a location where the audience is, a horse in another location, a horse in another city, a horse in another region and a horse in another country is arranged in sequential order. Searched information about a horse in the last few minutes, a horse in the last few hours, a horse in the last few days, a horse in the last few months, a horse in the last few years and a horse in the last few decades is arranged in sequential order. Searched information of a horse acquired by the audience in the last minute, acquired by the audience in the last few minutes, acquired by the audience in the last few dozens of minutes, acquired by the audience in the last few hours, acquired by the audience in the last few days and acquired by the audience in the last few months is arranged in sequential order. Searched information acquired by the audience in the last minute, acquired by the audience in the last few minutes, acquired by the audience in the last few dozens of minutes and acquired by the audience in the last few hours is arranged in sequential order.

In step S107, one piece of information in the context knowledge base is changed in a hypothetical manner, such that the generated information becomes in contradiction with a piece of information in the audience knowledge base, a meaning of the generated information changes or a way of the developing changes.

A piece of information (set as information M) in the context knowledge base changes into another piece of information (set as information N) in a hypothetical manner, such that the generated information A becomes in contradiction with a piece of information in the audience knowledge base, the meaning of the generated information A changes or the way in which the information A is developed to the information B changes. For example, information M “He is at home this evening” in a context knowledge base changes into information N “He is not at home this evening” in a hypothetical manner, such that a default context becomes a hypothetical context.

The information M is incompatible with the information N.

The information M is compatible with all information in the context knowledge base. The information N is compatible with all information in the context knowledge base except the information M and information caused by the information M.

The information M may be compatible with information in the audience knowledge base. The information N may be compatible with information in the audience knowledge base. The former is generally more likely than the latter. For example, in a default context knowledge base, a general is generally male. In fact, in an audience knowledge base, a general may be male or female. Two cases may be compatible with information in the audience knowledge base, but the former is generally more likely than the latter.

If it is desired to feel a sense of humor fast, the information M may be put higher in the ranking of the context knowledge base. If it is desired to feel a sense of humor slow, the information M may be put lower in the ranking of the context knowledge base.

If it is desired to achieve an effect of sarcasm, the information N may be in contradiction with a piece of information in the audience knowledge base and expresses positive information such as truth, compliance, appreciation or friendliness. If it is desired to achieve an effect of joking, the information N may be in contradiction with a piece of information in the audience knowledge base and expresses negative information such as fake, illegal, derogatory or offensive. For example, in “Assuming Li Ming has two bicycles, he will give one to his friend; Assuming Li Ming has two cars, he will give one to his friend; Assuming Li Ming has two houseboats, he will give one to his friend; Assuming Li Ming has two spaceships, he will give one to his friend”, a possibility of contradiction between hypothetical information and objective reality is increasing, rationality is getting smaller and smaller. It is obvious that Li Ming is from being praised to being satirized.

If it is desired to achieve an effect of funny, the information N may be not in contradiction with information in the audience knowledge base and the meaning of generated information becomes reality to be presented to an audience. When the hypothetical information becomes reality, the meaning of the generated information becomes reality and is directly presented to the audience. The audience can understand without thinking, in the hypothetical context, rationality of information which is irrational in the default context, such that the generated information is easy to be understood and seems funny. For example, information “A tiger and a sheep stay together peacefully” is irrational in the default context, but whether the information is rational in the hypothetical context is required to be thought by the audience. If hypothetical information “A Tiger does not harass a prey when it is full” is really existed, then feed the tiger well, such that the “A tiger and a sheep stay together peacefully” is directly presented to the audience, which seems funny.

If it is desired to achieve an effect of sophistry, the compatibility between displayed information with information in the audience knowledge base when the information N exists is regarded as the compatibility when the information M exists, that is, rationality in a hypothetical condition is regarded as rationality in a default condition, and, rationality in a hypothetical context is regarded as rationality in a default context.

If it is desired to enhance an effect of humor, the meaning of the information N or the meaning of displayed information when the information N exists is made to departure from a social rule that an audience is unwilling to accept or a fact that the audience is unwilling to recognize. The audience feels a sense of intellectual pride because the audience acquires virtual satisfaction and is hard to be punished. For example, the information N or the meaning of the displayed information when the information N exists attacks persons in another group in a joke.

The information M in the context knowledge base is changed into the information N in a hypothetical manner, such that information A in the hypothetical context becomes in contradiction with a piece of information in the audience knowledge base.

For example, information A “A person claimed to be son of a general, and the general admitted to being father of the person” is generated. A piece of information M “A general is male” in the context knowledge base is changed into information N “A general is female” in a hypothetical manner, such that the information A in the hypothetical context is in contradiction with a piece of information in the audience knowledge base.

Information M in a context knowledge base is changed into information N in a hypothetical manner, such that a meaning of information A changes in the hypothetical context.

For example, information A “If the boss does not take back what he said to me this morning, I'll leave the company” is generated. A piece of information M “I am on equal footing with the boss” in the context knowledge base is changes into information N “I was fired by the boss” in a hypothetical manner, such that a meaning of the information A changes from “I strongly demand an apology from the boss” into “I reluctantly obeyed”.

Information M in a context knowledge base is changed into information N in a hypothetical manner, such that the development way of information A changes in a hypothetical context.

For example, information A “Rainfall and temperature are moderate this year” is developed to information B “There may be a good crop this year”. There is a piece of information M “Moderate rainfall and temperature are necessary conditions for a good crop” in context information. A development way is that a premise may cause a conclusion. The information M changes into information N “Moderate rainfall and temperature are sufficient conditions for a good crop” in a hypothetical manner. The development way is that a premise must cause a conclusion. In a hypothetical context, the information A is developed to information D “There must be a good crop this year”.

For example, a piece of context information “A child said: I want to eat an apple” is generated. Generated information A “It is bedtime for children, not bedtime for adults” is developed to information B “Mom said: the apple is asleep”. Since there is a piece of information M “What apples and children have in common is decisive” in a context, it is developed to information B in an analogy way. When the information M is changed into information N “What big apples and adults have in common is decisive” in a hypothetical manner, the development way changes. Big apples are analogous to adults, such that the information A is developed into information D “The child said: the small one may be asleep, but the big one is certainly not asleep”.

Each of the information A and the information B may be a simple judgment or a composite judgment.

For example, information A “Since my hometown uses radio, there is no telephone wire in my hometown” is generated. A piece of context information M is “There is no telephone wire as long as radio is used”, in which information is developed in a development way of a sufficient condition. The information M is changed into information N “As long as radio is used, there is no telephone wire and only if the radio is used, there is no telephone wire” in a hypothetical manner, in which information is developed by using a premise as a necessary and sufficient condition. The information A is developed to information B “Since there is no telephone wire in my hometown, my hometown uses radio” in a hypothetical context.

Each of a context and a development may change more than once.

For example, “A child dropped his ice cream” is developed to “The child cried”. “The child cried” is further developed to “A passerby bought an ice cream for the child”. “A passerby bought an ice cream for the child” is further developed to “The child still has an ice cream to eat”. “The child still has an ice cream to eat” is further developed to “The child stopped crying”.

There is a piece of context information “The child cries only when he drops his ice cream”, in which “The child drops his ice cream” is developed into “The child cries” by using a premise as a necessary condition. In another piece of context information “A passerby buys an ice cream for the child only when the child cries”, “The child cries” is developed to “A passerby buys an ice cream for the child” by using a premise as a necessary condition.

The two pieces of context information are respectively changed into “A child cries without dropping an ice cream” or “A passerby will buy an ice cream for a child even if the child does not cry” in a hypothetical manner. That the ice cream is dropped is not a necessary condition for the child to cry, or that the child cries is not a necessary condition for the passerby to buy an ice cream for the child. “The child did not drop his ice cream” is developed to “The child cried” or “The child did not cry”. “The child did not cry” is further developed to “A passerby bought an ice cream for the child”. “A passerby bought an ice cream for the child” is further developed to “The child had two ice creams to eat”.

“If a child did not drop his ice cream, he had two ice creams to eat” is developed to “Because a child dropped his ice cream, the child cried again”, in which each of an premise and a result of the development is a composite judgment.

Changing of a default context in a hypothetical manner is a negation on rationality.

In step S108, the generated information or the way of developing is changed based on the changed information in the context knowledge base.

Since information or the development becomes irrational due to a change of a context, the generated information or the development is changed based on the changed information in the context knowledge base.

When information A becomes in contradiction with a piece of information in the audience knowledge base in the hypothetical context, the information A becomes another piece of information (set as information C). The information C is in contradiction with a piece of information in the audience knowledge base in the default context and is not in contradiction with the piece of information in the audience knowledge base in the hypothetical context.

Specifically, the information M in the context knowledge base is changed into the information N in a hypothetical manner and the information A is changed into the information C in the hypothetical context. Information C has a same meaning in the default context and in the hypothetical context, but a relation between the information C and the piece of information in the audience knowledge base changes from contradictory in the default context to non-contradictory in the hypothetical context.

For example, information A “A person claimed to be son of a general, and the general admitted to being father of the person” is generated in the default context. The information A is rational in the default context. A piece of information M “A general is male” in the context knowledge base is changed into information N “A general is female” in a hypothetical manner, such that the information A is irrational in the hypothetical context. In the hypothetical context, the information A is changed into information C “A person claimed to be son of a general, but the general did not admit to being father of the person”. The information C is irrational in the default context but is rational in the hypothetical context. The information C is displayed.

Specifically, information M in the context knowledge base is changed into information N in a hypothetical manner, and information A is changed into information C in the hypothetical context. The information C has different meanings in the default context and in the hypothetical context, and a relation between the information C and a piece of information in the audience knowledge base changes from contradictory in the default context to non-contradictory in the hypothetical context.

For example, a knowledge base is established and information such as “Wang Fan has directed the most films in China” and “Li Ming has more children than any other director in China” is acquired from the audience knowledge base. Information A “Wang Fan is the most prolific director in China” or “Li Ming is not the most prolific director in China” is generated in a default context. The information A is rational in the default context. A piece of information M “This is talking about movies” in a context knowledge base is changed into information N “This is talking about having children” in a hypothetical manner, such that the information A becomes irrational in a hypothetical context. The information A is changed into information C “Li Ming is the most prolific director in China” in the hypothetical context. The information C has different meanings in the default context and in the hypothetical context. The information C is irrational in the default context and is rational in the hypothetical context. The information C is displayed.

When a meaning of information A changes, the information A is changed into another piece of information (set as information E). The information E has the same form with the information A. The information E has different meanings in the hypothetical context and in the default context.

Specifically, the information M in the context knowledge base is changed into the information N in a hypothetical manner, and the information A is changed into the information E in the hypothetical context. The information E has the same form with the information A. The information E has different meanings in the hypothetical context and in the default context. The information E is displayed and then the information N is displayed.

For example, information A “If the boss does not take back what he said to me this morning, I'll leave the company” is generated. In a default context including information such as a piece of information M “I am on equal footing with the boss”, a meaning of the information A is “I strongly demand an apology from the boss”. The information M in the context knowledge base is changed into information N “I was fired by the boss” in a hypothetical manner. The information A having a form of “If the boss does not take back what he said to me this morning, I'll leave the company” and having a meaning of “I strongly demand an apology from the boss” becomes information E having a same form but having a meaning of “I reluctantly obeyed”. The information E is displayed and then the information N is displayed.

When the meaning of information A or the way of developing changes, a way of developing the information A to information B becomes a way of developing the information A to another piece of information (set as information D).

Specifically, the information M in the context knowledge base is changed into information N in a hypothetical manner. When a meaning of information A changes, the information A is developed to the information D. When the meaning of the information A changes into another meaning, it is developed to the information D from such another meaning. The information A is displayed and then the information D is displayed.

For example, information A “An employee said: the day before yesterday I just got into the elevator, the inside suddenly became dark, which scared me to death” is generated. The information A is developed to information B “Hearing this, the manager said: I will arrange the safety inspection of the elevator immediately”. A piece of information M in the context is “The employee is talking about safety problem”. In the default context, a meaning of the information A is “The employee is concerned about that it may be dangerous in the elevator”. The information M is changed into information N “The employee is talking about a lighting problem” in a hypothetical manner, such that in the hypothetical context the information A having a meaning of “The employee is complaining that the elevator is too dark” is developed to information D “Hearing this, the manager said: Each of you will be equipped with a flashlight”. The information A is displayed and then the information D is displayed.

Specifically, the information M in the context knowledge base is changed into information N in a hypothetical manner and the development way of the information A changes into another one, such that the information A is developed to information D through the changed development way. The information A is displayed and then the information D is displayed.

For example, information A “Rainfall and temperature are moderate this year” is developed to information B “There may be a good crop this year”. There is a piece of information M “Moderate rainfall and temperature are necessary conditions for a good crop” in context information. A development way is that a premise may cause a conclusion. The information M is changed into information N “Moderate rainfall and temperature are sufficient conditions for a good crop” in a hypothetical manner. The development way is that a premise must cause a conclusion. In a hypothetical context, the information A is developed to information D “There must be a good crop this year”. A process of developing from the information A to the information D is displayed.

For example, a piece of context information “A child said: I want to eat an apple” is generated. Generated information A “It is bedtime for children, not bedtime for adults” is developed to information B “Mom said: the apple is asleep”. Since there is a piece of information M “What apples and children have in common is decisive” in a context, the information A is developed to information B in an analogy development way. When the information M is changed into information N “What big apples and adults have in common is decisive” in a hypothetical manner, the development way changes. Big apples are analogous to adults, such that the information A is developed into information D “The child said: the small one may be asleep, but the big one is certainly not asleep”. The context information, a process of developing from the information A to the information B, and a process of developing from the information A to the information D may be displayed.

Changing of a default context in a hypothetical manner is a negation on rationality. Changing in a hypothetical context is negation on a negation of the rationality, which makes a robot have a sense of humor.

In step S109, the changed generated information, hypothetical information, or a changed development is displayed.

Finally, the changed generated information, the hypothetical information, or the changed development is displayed. In an embodiment, the information C is displayed. In an embodiment, the information E is displayed and then the information N is displayed. In an embodiment, the information A is displayed and then the information D is displayed. The information A has a meaning different from that of the information E but has the same form with the information E. Displaying the information A has the same effect with displaying the information E.

A sense of humor of the robot is showed.

In view of the above, a unique theoretical basis of the present disclosure is that humor is a subconscious negation on a negation of rationality. In the present disclosure, human mental activities are simulated based on large amount of information storage and a fast computing speed of a robot. Through comprehensive technical means, an audience can feel a sense of humor of the robot, where the humor includes skillful handling of rationality. The robot consciously negates the negation of the rationality, and the audience subconsciously recalls such process of the robot. The rationality is determined based on contradictionariness between displayed information and all information known and approved by the audience such as a fact and a rule in the fields of nature, thought, society and the like. Contradiction causes irrationality, and non-contradiction causes rationality. For example, according to the law of identity of thinking, it is rational that a definite expression form has a definite meaning in a definite context. The rationality is directed to a specific audience, which rational for an audience may not be rational for another audience. A person may think that some things are true and some rules should be accepted, but another person may not think so. For example, most people think that “The Earth goes around the Sun” is true, but a few people think that “The Sun goes around the Earth” is true.

There are three levels of technical means of the present disclosure. In a first level of the technical means, through tacit sharing of displayed content, contradiction becomes non-contradiction, thereby achieving an effect of humor. The first level of the technical means mainly relates to the fields of psychology and philosophy. In a second level of the technical means, through a common context shared by the audience and the robot, a tacit sharing is achieved. By switching a default context to a hypothetical context, contradiction of the displayed content becomes non-contradiction. The second level of the technical means mainly relates to the fields of logic and linguistics. In a third level of the technical means, by establishing a context knowledge base, a common context is established. By changing a data base, a context changes. The context knowledge base is established mainly through an audience knowledge base. The audience knowledge base is established mainly through a group knowledge base. The third level of the technical means mainly relates to the field of computers.

An audience recalls a process of generating humorous information by the robot. The audience initially fells irrational about the content displayed by the robot, such that the audience fells nervous and confused, and suspects that he or she may have a misunderstanding of the displayed content or an error may occur in the intelligent robot. Next, the audience determines that he or she probably did not misunderstand the content and an error may not occur in the robot, so the audience tries to rationalize the expression of the robot. Then, the audience finds that the expression of the robot is rational in a hypothetical context and that the expression is a negation on a negation of rationality. Finally, through common background knowledge, the audience experiences tacit discovery and sharing of a secret, thereby laughs due to felling intellectual pride, a sense of identity, tacit understanding, relaxation, pleasure, and amusement.

In the present disclosure, humor is generated from general information. The generated humor is rich in content and has an obvious humorous effect. It is to overcome limitations of depending on human ready-made humor materials and mainly generating a word play in other technologies for generating humorous personality of a robot.

An effect of generating humorous information of a robot can be tested. In a test method, a tested robot answers a question in the Turing test. In this case, a success rate at which the robot fools human is set as S. Then persons with a strong sense of humor humorously answer a question together with the robot. In this case, a success rate at which the robot fools human is set as T. Then a ratio of a success rate at which the robot imitating human's humor to a success rate at which the robot imitating other human characteristics is T/S. If T/S is close to or greater than 1, it indicates that the robot imitates human's humor successfully. In another test method, some people with a strong sense of humor humorously and anonymously answer a question together with the robot. A human audience determines humor scores of the people and the robot. A ranking of the robot among all answerers represents a score of a humor sense of the robot. If the ranking is in the top 50 percent, it indicates that the robot has a stronger sense of humor than humans.

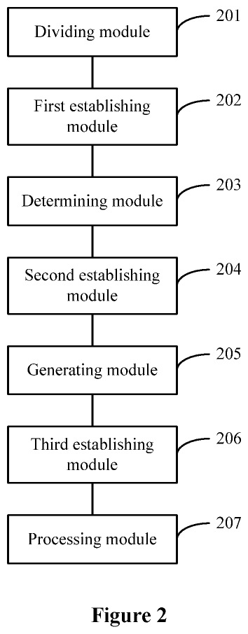

As shown in FIG. 2, FIG. 2 is a structural schematic diagram of a system for generating humorous personality information of a robot based on a knowledge base according to a first embodiment of the present disclosure. The system may include a dividing module 201, a first establishing module 202, a determining module 203, a second establishing module 204, a generating module 205, a third establishing module 206 and a processing module 207.

The dividing module 201 is configured to divide groups.

When it is required to generate humorous personality information of a robot based on a knowledge base, firstly groups are divided based on group features such as age, gender, education, profession, occupation, class, language, ethnicity, race, interest, hobby, belief, religion, region, country or culture as a criterion, such that the following steps are performed targeting an audience in a certain group.

Specifically, groups may be divided into “Chinese”, “American”, “Japanese” and the like based on nationality.

Specifically, groups may be divided into “doctor”, “teacher”, “farmer” and the like based on occupation.

The first establishing module 202 is configured to establish a group knowledge base with each group prediction as an information classification criterion.

The group knowledge base is established by using each group prediction as an information classification criterion, rather than using some key words contained in contents as a criterion. Prediction information refers to as information that a certain group is likely to know. Group prediction information forms a group knowledge unit, and a group knowledge unit forms a group knowledge base. A simple group knowledge base may only include one group knowledge unit, while a complex group knowledge base may include multiple group knowledge units. A group knowledge base including only one group knowledge unit is only directed to one group, and a group knowledge base including multiple group knowledge units may be directed to multiple groups. The group knowledge base provides an information source for an audience knowledge base.

For example, a group knowledge base including only one “Chinese” group knowledge unit can only make a Chinese feel humor of a robot. Information that a “Chinese” group is likely to know such as “Beijing is a city”, “Beijing is in the north of China”, “China has a long history”, “Vietnam is to the south of China” and “The Yangtze River is longer than the Yellow River” is organized together by using “Chinese” group predictions as a criterion, to establish a “Chinese” group knowledge unit, and thus establish a group knowledge base.

Specifically, a group knowledge base may simultaneously include a “Chinese” group knowledge unit, an “American” group knowledge unit, and a “German” group knowledge unit. A group knowledge base may also simultaneously include a “worker” group knowledge unit, a “farmer” group knowledge unit, a “lawyer” group knowledge unit, a “doctor” group knowledge unit and the like.

Specifically, information that a “junior school student” group is likely to know such as “addition, subtraction, multiplication and division operational rules” is organized together by using “junior school student” group predictions as a criterion, to establish a “junior school student” group knowledge unit.

Specifically, information that a “Chinese junior school student” group is likely to know is organized together by using “Chinese junior school student” predictions as a criterion to establish a “Chinese junior school student” group knowledge unit. The information that the “Chinese junior school student” group is likely to know simultaneously includes information that whole of a “Chinese” group is likely to know and information that whole of a “junior school student” group is likely to know, and information that a “junior school student” part of the “Chinese” group, which is a “Chinese” part of the “junior school student” group is likely to know, such as information of Chinese senior high school entrance examination.

Specifically, prediction information of a “Chinese male junior school student” group is organized together by using “Chinese male junior school student” predictions as a criterion to form a “Chinese male junior school student” group knowledge unit.

The determining unit 203 is configured to determine a group type of an audience.

A group type of an audience is determined by using audience features such as age, gender, education, country or profession of the audience as a criterion.

For example, it is determined that an audience belongs to the “Chinese” group.

For example, it is determined that an audience belongs to a “male” group, the “Chinese” group and the “junior school student” group.

The second establishing unit 204 is configured to establish, from the group knowledge base, an audience knowledge base with an audience prediction as an information classification criterion.

The audience knowledge base is established from the group knowledge base by using the audience prediction as the information classification criterion. Prediction information refers to as information that an audience is likely to know.

Specifically, in a case that a group knowledge base includes a ready-made group knowledge unit for a group to which an audience belongs, information of an audience knowledge base directly uses the group knowledge unit for the group to which the audience belongs. For example, in a case that the group knowledge base includes a “Chinese junior school student” group knowledge unit, a “Chinese junior school student” audience knowledge base directly uses the “Chinese junior school student” group knowledge unit.

Specifically, in a case that a group knowledge base does not include a ready-made group knowledge unit for a group to which an audience belongs, an audience knowledge base of an audience having features that belong to an intersection set of features of multiple groups uses a union set of group knowledge units having these features. For example, a “Chinese football fan” is an audience having features that belong to an intersection set of features of a “Chinese” and features of a “football fan”. In a case that a group knowledge base includes a “Chinese” group knowledge unit and a “football fan” group knowledge unit but does not include a “Chinese football fan” group knowledge unit, a “Chinese football fan” audience knowledge base uses a union set of the “Chinese” group knowledge unit and the “football fan” group knowledge unit. More features of an audience, then more pieces of information in an audience knowledge base. If an audience has no features, information in the audience knowledge base only includes contents that all human being know.

Specifically, in a case that a group knowledge base does not include a ready-made group knowledge unit for a group to which an audience belongs, an audience knowledge base of an audience having features that belong to a union set of features of multiple groups uses an intersection set of group knowledge units having these features. For example, a “Chinese or football fan” audience has features that belong to a union set of features of a “Chinese” and features of a “football fan”. In a case that a group knowledge base includes a “Chinese” group knowledge unit and a “football fan” group knowledge unit but does not include a “Chinese or football fan” group knowledge unit, a “Chinese or football fan” audience knowledge base uses an intersection set of the “Chinese” group knowledge unit and the “football fan” group knowledge unit.

The audience knowledge base enables an audience and a robot to share information in a common context.

The generating unit 205 is configured to generate a piece of information or developing, from the piece of information to another piece of information.

A piece of information (set as information A) is generated or the piece of information is developed to another piece of information (set as information B). The information may be in the form of a language or a character such as a word, a phrase and a sentence. The information may also be in a form of a tone, an face expression, an body action, a behavior, an event and the like, which are expressed in a form of language or character such as a word, a phrase and a sentence.

In a particular language, a same word, phrase or sentence may express different meanings in different contexts. A same word, phrase, sentence, tone, face expression, body action, behavior, event and the like may express different meanings in different contexts.

Specifically, a single word can express information. For example, a famous entertainer in Hong Kong is called as Guo-rong Cheung, Guo-rong, Leslie, young master Rong, elder brother, uncle Cheung, monkey Cheung and the like, which express different meanings.

For example, “He stood up suddenly” may express a shallow meaning, which refers to an act that a leg rapidly moves from bent to straight, and may also express a different deep meaning in a different context that the action may express anger, pleasure, excitement, impulsion, obedience, opposing, yielding, applauding, supporting, demonstrating, leaving, receiving an instruction or taking an action.

For example, “The weather is good today” expresses a physical state of the weather in a weather forecasting context, while mainly expresses kindness and goodwill in a social context.

In a case that the information A is developed to information B, the information A may be generated information or received information.

For example, in “I am a little hungry, I want to eat”, the former sentence is developed to the later sentence. Both the former sentence and the later sentence are newly generated information.

For example, in a dialogue “Does your house often leak rain?”, “No, it leaks only when it rains”, the former sentence is also developed to the later sentence. The former sentence may be information from somebody else.

The third establishing module 206 is configured to establish a context knowledge base.

Information searched from an audience knowledge base by using a word forming a sentence of the information A or the information B as a key word and information that an audience just received may serve as contents in the context knowledge base. Searched information including a key word closely related to information to be displayed in content, in time or in space or information that recently acquired by the audience is arranged in front to establish the context knowledge base. With the context knowledge base, the displayed information form has an exact meaning.

For example, when it is desired to establish a “Li Ming rides a horse on a grassland” context knowledge base, a search is performed on an audience knowledge base by using “Li Ming”, “grassland”, “ride” and “horse” as key words. Searched information about a horse, a large mammal, a mammal, an animal, and a living being is arranged in sequential order. Searched information about a horse in a location where the audience is, a horse in another location, a horse in another city, a horse in another region and a horse in another country is arranged in sequential order. Searched information about a horse in the last few minutes, a horse in the last few hours, a horse in the last few days, a horse in the last few months, a horse in the last few years and a horse in the last few decades is arranged in sequential order. Searched information of a horse acquired by the audience in the last minute, acquired by the audience in the last few minutes, acquired by the audience in the last few dozens of minutes, acquired by the audience in the last few hours, acquired by the audience in the last few days and acquired by the audience in the last few months is arranged in sequential order. Searched information acquired by the audience in the last minute, acquired by the audience in the last few minutes, acquired by the audience in the last few dozens of minutes and acquired by the audience in the last few hours is arranged in sequential order.

The processing module 207 is configured to change one piece of information in the context knowledge base in a hypothetical manner, such that the generated information becomes in contradiction with a piece of information in the audience knowledge base, a meaning of the generated information changes or a way of the developing changes; change the generated information or change the way of developing based on the changed information in the context knowledge base and display the changed generated information, hypothetical information, or a changed development.

A piece of information (set as information M) in the context knowledge base changes into another piece of information (set as information N) in a hypothetical manner, such that the generated information A becomes in contradiction with a piece of information in the audience knowledge base, the meaning of the generated information A changes or the way in which the information A is developed to the information B changes. For example, information M “He is at home this evening” in a context knowledge base changes into information N “He is not at home this evening” in a hypothetical manner, such that a default context becomes a hypothetical context.

The information M is incompatible with the information N.

The information M is compatible with all information in the context knowledge base. The information N is compatible with all information in the context knowledge base except the information M and information caused by the information M.

The information M may be compatible with all information in the audience knowledge base. The information N may be compatible with all information in the audience knowledge base. The former is generally more likely than the latter. For example, in a default context knowledge base, a general is generally male. In fact, in an audience knowledge base, a general may be male or female. Two cases may be compatible with information in the audience knowledge base, but the former is generally more likely than the latter.

If it is desired to feel a sense of humor fast, the information M may be put higher in the ranking of the context knowledge base. If it is desired to feel a sense of humor slow, the information M may be put lower in the ranking of the context knowledge base.

If it is desired to achieve an effect of sarcasm, the information N may be in contradiction with a piece of information in the audience knowledge base and expresses positive information such as truth, compliance, appreciation or friendliness. If it is desired to achieve an effect of joking, the information N may be in contradiction with a piece of information in the audience knowledge base and expresses negative information such as fake, illegal, derogatory or offensive. For example, in “Assuming Li Ming has two bicycles, he will give one to his friend; Assuming Li Ming has two cars, he will give one to his friend; Assuming Li Ming has two houseboats, he will give one to his friend; Assuming Li Ming has two spaceships, he will give one to his friend”, a possibility of contradiction between hypothetical information and objective reality is increasing, rationality is getting smaller and smaller. It is obvious that Li Ming is from being praised to being satirized.

If it is desired to achieve an effect of funny, the information N may be not in contradiction with information in the audience knowledge base and the meaning of generated information becomes reality to be presented to an audience. When the hypothetical information becomes reality, the meaning of the generated information becomes reality and is directly presented to the audience. The audience can understand without thinking, in the hypothetical context, rationality of information which is irrational in the default context, such that the generated information is easy to be understood and seems funny. For example, information “A tiger and a sheep stay together peacefully” is irrational in the default context, but whether the information is rational in the hypothetical context is required to be thought by the audience. If hypothetical information “A Tiger does not harass a prey when it is full” is really existed, then feed the tiger well, such that the “A tiger and a sheep stay together peacefully” is directly presented to the audience, which seems funny.

If it is desired to achieve an effect of sophistry, the compatibility between displayed information with information in the audience knowledge base when the information N exists is regarded as the compatibility when the information M exists, that is, rationality in a hypothetical condition is regarded as rationality in a default condition, and, rationality in a hypothetical context is regarded as rationality in a default context.

If it is desired to enhance an effect of humor, the meaning of the information N or the meaning of displayed information when the information N exists is made to departure from a social rule that an audience is unwilling to accept or a fact that the audience is unwilling to recognize. The audience feels a sense of intellectual pride because the audience acquires virtual satisfaction and is hard to be punished. For example, the information N or the meaning of the displayed information when the information N exists attacks persons in another group in a joke.

The information M in the context knowledge base is changed into the information N in a hypothetical manner, such that information A in the hypothetical context becomes in contradiction with a piece of information in the audience knowledge base.

For example, information A “A person claimed to be son of a general, and the general admitted to being father of the person” is generated. A piece of information M “A general is male” in the context knowledge base is changed into information N “A general is female” in a hypothetical manner, such that the information A in the hypothetical context is in contradiction with a piece of information in the audience knowledge base.

Information M in a context knowledge base is changed into information N in a hypothetical manner, such that a meaning of information A changes in the hypothetical context.

For example, information A “If the boss does not take back what he said to me this morning, I'll leave the company” is generated. A piece of information M “I am on equal footing with the boss” in the context knowledge base is changes into information N “I was fired by the boss” in a hypothetical manner, such that a meaning of the information A changes from “I strongly demand an apology from the boss” into “I reluctantly obeyed”.

Information M in a context knowledge base is changed into information N in a hypothetical manner, such that a development way of information A changes in a hypothetical context.

For example, information A “Rainfall and temperature are moderate this year” is developed to information B “There may be a good crop this year”. There is a piece of information M “Moderate rainfall and temperature are necessary conditions for a good crop” in context information. A development way is that a premise may cause a conclusion. The information M changes into information N “Moderate rainfall and temperature are sufficient conditions for a good crop” in a hypothetical manner. The development way is that a premise must cause a conclusion. In a hypothetical context, the information A is developed to information D “There must be a good crop this year”.

For example, a piece of context information “A child said: I want to eat an apple” is generated. Generated information A “It is bedtime for children, not bedtime for adults” is developed to information B “Mom said: the apple is asleep”. Since there is a piece of information M “What apples and children have in common is decisive” in a context, it is developed to information B in an analogy way. When the information M is changed into information N “What big apples and adults have in common is decisive” in a hypothetical manner, the development way changes. Big apples are analogous to adults, such that the information A is developed into information D “The child said: the small one may be asleep, but the big one is certainly not asleep”.

Each of the information A and the information B may be a simple judgment or a composite judgment.

For example, information A “Since my hometown uses radio, there is no telephone wire in my hometown” is generated. A piece of context information M is “There is no telephone wire as long as radio is used”, in which information is developed in a development way of a sufficient condition. The information M is changed into information N “As long as radio is used, there is no telephone wire and only if the radio is used, there is no telephone wire” in a hypothetical manner, in which information is developed by using a premise as a necessary and sufficient condition. The information A is developed to information B “Since there is no telephone wire in my hometown, my hometown uses radio” in a hypothetical context.

Each of a context and a development may change more than once.

For example, “A child dropped his ice cream” is developed to “The child cried”. “The child cried” is further developed to “A passerby bought an ice cream for the child”. “A passerby bought an ice cream for the child” is further developed to “The child still has an ice cream to eat”. “The child still has an ice cream to eat” is further developed to “The child stopped crying”.

There is a piece of context information “The child cries only when he drops his ice cream”, in which “The child drops his ice cream” is developed into “The child cries” by using a premise as a necessary condition. In another piece of context information “A passerby buys an ice cream for the child only when the child cries”, “The child cries” is developed to “A passerby buys an ice cream for the child” by using a premise as a necessary condition.

The two pieces of context information are respectively changed into “A child cries without dropping an ice cream” or “A passerby will buy an ice cream for a child even if the child does not cry” in a hypothetical manner. That the ice cream is dropped is not a necessary condition for the child to cry, or that the child cries is not a necessary condition for the passerby to buy an ice cream for the child. “The child did not drop his ice cream” is developed to “The child cried” or “The child did not cry”. “The child did not cry” is further developed to “A passerby bought an ice cream for the child”. “A passerby bought an ice cream for the child” is further developed to “The child had two ice creams to eat”.

“If a child did not drop his ice cream, he had two ice creams to eat” is developed to “Because a child dropped his ice cream, the child cried again”, in which each of an premise and a result of the development is a composite judgment.

Changing of a default context in a hypothetical manner is a negation on rationality.

Since information or the development becomes irrational due to a change of a context, the generated information or the development is changed based on the changed information in the context knowledge base.

When information A becomes in contradiction with a piece of information in the audience knowledge base in the hypothetical context, the information A becomes another piece of information (set as information C). The information C is in contradiction with a piece of information in the audience knowledge base in the default context and is not in contradiction with the piece of information in the audience knowledge base in the hypothetical context.

Specifically, the information M in the context knowledge base is changed into the information N in a hypothetical manner and the information A is changed into the information C in the hypothetical context. Information C has a same meaning in the default context and in the hypothetical context, but a relation between the information C and the piece of information in the audience knowledge base changes from contradictory in the default context to non-contradictory in the hypothetical context.

For example, information A “A person claimed to be son of a general, and the general admitted to being father of the person” is generated in the default context. The information A is rational in the default context. A piece of information M “A general is male” in the context knowledge base is changed into information N “A general is female” in a hypothetical manner, such that the information A is irrational in the hypothetical context. In the hypothetical context, the information A is changed into information C “A person claimed to be son of a general, but the general did not admit to being father of the person”. The information C is irrational in the default context but is rational in the hypothetical context. The information C is displayed.

Specifically, information M in the context knowledge base is changed into information N in a hypothetical manner, and information A is changed into information C in the hypothetical context. The information C has different meanings in the default context and in the hypothetical context, and a relation between the information C and a piece of information in the audience knowledge base changes from contradictory in the default context to non-contradictory in the hypothetical context.

For example, a knowledge base is established and information such as “Wang Fan has directed the most films in China” and “Li Ming has more children than any other director in China” is acquired from the audience knowledge base. Information A “Wang Fan is the most prolific director in China” or “Li Ming is not the most prolific director in China” is generated in a default context. The information A is rational in the default context. A piece of information M “This is talking about movies” in a context knowledge base is changed into information N “This is talking about having children” in a hypothetical manner, such that the information A becomes irrational in a hypothetical context. The information A is changed into information C “Li Ming is the most prolific director in China” in the hypothetical context. The information C has different meanings in the default context and in the hypothetical context. The information C is irrational in the default context and is rational in the hypothetical context. The information C is displayed.

When a meaning of information A changes, the information A is changed into another piece of information (set as information E). The information E has the same form with the information A. The information E has different meanings in the hypothetical context and in the default context.

Specifically, the information M in the context knowledge base is changed into the information N in a hypothetical manner, and the information A is changed into the information E in the hypothetical context. The information E has the same form with the information A. The information E has different meanings in the hypothetical context and in the default context. The information E is displayed and then the information N is displayed.

For example, information A “If the boss does not take back what he said to me this morning, I'll leave the company” is generated. In a default context including information such as a piece of information M “I am on equal footing with the boss”, a meaning of the information A is “I strongly demand an apology from the boss”. The information M in the context knowledge base is changed into information N “I was fired by the boss” in a hypothetical manner. The information A having a form of “If the boss does not take back what he said to me this morning, I'll leave the company” and having a meaning of “I strongly demand an apology from the boss” becomes information E having a same form but having a meaning of “I reluctantly obeyed”. The information E is displayed and then the information N is displayed.

When the meaning of information A or the way of developing changes, a way of developing the information A to information B becomes a way of developing the information A to another piece of information (set as information D).

Specifically, the information M in the context knowledge base is changed into information N in a hypothetical manner. When a meaning of information A changes, the information A is developed to the information D. When the meaning of the information A changes into another meaning, it is developed to the information D from such another meaning. The information A is displayed and then the information D is displayed.

For example, information A “An employee said: the day before yesterday I just got into the elevator, the inside suddenly became dark, which scared me to death” is generated. The information A is developed to information B “Hearing this, the manager said: I will arrange the safety inspection of the elevator immediately”. A piece of information M in the context is “The employee is talking about safety problem”. In the default context, a meaning of the information A is “The employee is concerned about that it may be dangerous in the elevator”. The information M is changed into information N “The employee is talking about a lighting problem” in a hypothetical manner, such that in the hypothetical context the information A having a meaning of “The employee is complaining that the elevator is too dark” is developed to information D “Hearing this, the manager said: Each of you will be equipped with a flashlight”. The information A is displayed and then the information D is displayed.

Specifically, the information M in the context knowledge base is changed into information N in a hypothetical manner and a development way of the information A changes into another one, such that the information A is developed to information D through the changed development way. The information A is displayed and then the information D is displayed.

For example, information A “Rainfall and temperature are moderate this year” is developed to information B “There may be a good crop this year”. There is a piece of information M “Moderate rainfall and temperature are necessary conditions for a good crop” in context information. A development way is that a premise may cause a conclusion. The information M is changed into information N “Moderate rainfall and temperature are sufficient conditions for a good crop” in a hypothetical manner. The development way is that a premise must cause a conclusion. In a hypothetical context, the information A is developed to information D “There must be a good crop this year”. A process of developing from the information A to the information D is displayed.

For example, a piece of context information “A child said: I want to eat an apple” is generated. Generated information A “It is bedtime for children, not bedtime for adults” is developed to information B “Mom said: the apple is asleep”. Since there is a piece of information M “What apples and children have in common is decisive” in a context, the information A is developed to information B in an analogy development way. When the information M is changed into information N “What big apples and adults have in common is decisive” in a hypothetical manner, the development way changes. Big apples are analogous to adults, such that the information A is developed into information D “The child said: the small one may be asleep, but the big one is certainly not asleep”. The context information, a process of developing from the information A to the information B, and a process of developing from the information A to the information D may be displayed.

Changing of a default context in a hypothetical manner is a negation on rationality. Changing in a hypothetical context is negation on a negation of the rationality, which makes a robot have a sense of humor.

Finally, the changed generated information, the hypothetical information, or the changed development is displayed. In an embodiment, the information C is displayed. In an embodiment, the information E is displayed and then the information N is displayed. In an embodiment, the information A is displayed and then the information D is displayed. The information A has a meaning different from that of the information E but has the same form with the information E. Displaying the information A has the same effect with displaying the information E.

A sense of humor of the robot is showed.

In view of the above, a unique theoretical basis of the present disclosure is that humor is a subconscious negation on a negation of rationality. In the present disclosure, human mental activities are simulated based on large amount of information storage and a fast computing speed of a robot. Through comprehensive technical means, an audience can feel a sense of humor of the robot, where the humor includes skillful handling of rationality. The robot consciously negates the negation of the rationality, and the audience subconsciously recalls such process of the robot. The rationality is determined based on contradictionariness between displayed information and all information known and approved by the audience such as a fact and a rule in the fields of nature, thought, society and the like. Contradiction causes irrationality, and non-contradiction causes rationality. For example, according to the law of identity of thinking, it is rational that a definite expression form has a definite meaning in a definite context. The rationality is directed to a specific audience, which rational for an audience may not be rational for another audience. A person may think that some things are true and some rules should be accepted, but another person may not think so. For example, most people think that “The Earth goes around the Sun” is true, but a few people think that “The Sun goes around the Earth” is true.

There are three levels of technical means of the present disclosure. In a first level of the technical means, through tacit sharing of displayed content, contradiction becomes non-contradiction, thereby achieving an effect of humor. The first level of the technical means mainly relates to the fields of psychology and philosophy. In a second level of the technical means, through a common context shared by the audience and the robot, a tacit sharing is achieved. By switching a default context to a hypothetical context, contradiction of the displayed content becomes non-contradiction. The second level of the technical means mainly relates to the fields of logic and linguistics. In a third level of the technical means, by establishing a context knowledge base, a common context is established. By changing a data base, a context changes. The context knowledge base is established mainly through an audience knowledge base. The audience knowledge base is established mainly through a group knowledge base. The third level of the technical means mainly relates to the field of computers.

An audience recalls a process of generating humorous information by the robot. The audience initially fells irrational about the content displayed by the robot, such that the audience fells nervous and confused, and suspects that he or she may have a misunderstanding of the displayed content or an error may occur in the intelligent robot. Next, the audience determines that he or she probably did not misunderstand the content and an error may not occur in the robot, so the audience tries to rationalize the expression of the robot. Then, the audience finds that the expression of the robot is rational in a hypothetical context and that the expression is a negation on a negation of rationality. Finally, through common background knowledge, the audience experiences tacit discovery and sharing of a secret, thereby laughs due to felling intellectual pride, a sense of identity, tacit understanding, relaxation, pleasure, and amusement.

In the present disclosure, humor is generated from general information. The generated humor is rich in content and has an obvious humorous effect. It is to overcome limitations of depending on human ready-made humor materials and mainly generating a word play in other technologies for generating humorous personality of a robot.

An effect of generating humorous information of a robot can be tested. In a test method, a tested robot answers a question in the Turing test. In this case, a success rate at which the robot fools human is set as S. Then persons with a strong sense of humor humorously answer a question together with the robot. In this case, a success rate at which the robot fools human is set as T. Then a ratio of a success rate at which the robot imitating human's humor to a success rate at which the robot imitating other human characteristics is T/S. If T/S is close to or greater than 1, it indicates that the robot imitates human's humor successfully. In another test method, some people with a strong sense of humor humorously and anonymously answer a question together with the robot. A human audience determines humor scores of the people and the robot. A ranking of the robot among all answerers represents a score of a humor sense of the robot. If the ranking is in the top 50 percent, it indicates that the robot has a stronger sense of humor than humans.

The embodiments in this specification are described in a progressive way, each of which emphasizes the differences from others, and the same or similar parts among the embodiments can be referred to each other. Since the device disclosed in the embodiments corresponds to the method therein, the description thereof is relatively simple, and for relevant matters references may be made to the description of the method.

It is to be further understood by those skilled in the art that may further realize that the units and algorithm steps of each example described in conjunction with the embodiments disclosed herein may be implemented by electronic hardware, computer software, or the combination thereof. In order to clearly explain the interchangeability of hardware and software, in the above description, the composition and steps of each example have been generally described in terms of function. Whether these functions are executed in hardware or software depends on the specific application of the technical solution and design constraints. Those skilled in the art may use different methods to implement the described functions for each specific application, but such implementation should not be considered beyond the scope of the present disclosure.

The steps of the method or algorithm described in conjunction with the embodiments disclosed herein may be implemented directly by hardware, a software module executed by a processor, or a combination thereof. The software module may be placed in random access memory (RAM), memory, read-only memory (ROM), electrically programmable ROM, electrically erasable programmable ROM, register, hard disk, removable disk, CD-ROM, or any other storage medium well known in the art.

With the description of the embodiments disclosed above, those skilled in the art may implement or use technical solutions of the present disclosure. Various modifications to the embodiments are apparent to those skilled in the art, and the general principles defined herein may be implemented in other embodiments without departing from the spirit or scope of the present disclosure. Therefore, the present disclosure may not be limited to the embodiments described herein, but should comply with the widest scope consistent with the principles and novel features disclosed herein.

1. A method for generating humorous personality information of a robot based on a knowledge base, wherein the method comprises:
dividing groups;
establishing a group knowledge base with each group prediction as an information classification criterion;
determining a group type of an audience;
establishing, from the group knowledge base, an audience knowledge base with an audience prediction as an information classification criterion;
generating a piece of information, or developing, from the piece of information to another piece of information;
establishing a context knowledge base;
changing one piece of information in the context knowledge base in a hypothetical manner, such that the generated information becomes in contradiction with a piece of information in the audience knowledge base, a meaning of the generated information changes, or a way of the developing changes;
changing the generated information or changing the way of developing, based on the changed information in the context knowledge base; and
displaying the changed generated information, hypothetical information, or a changed development.

2. A system for generating humorous personality information of a robot based on a knowledge base, wherein the system comprises:
a dividing module, configured to divide groups;
a first establishing module, configured to establish a group knowledge base with each group prediction as an information classification criterion;
a determining module, configured to determine a group type of an audience;
a second establishing module, configured to establish, from the group knowledge base, an audience knowledge base with an audience prediction as an information classification criterion;
a generating module, configured to generate a piece of information or developing, from the piece of information to another piece of information;
a third establishing module, configured to establish a context knowledge base; and
a processing module, configured to change one piece of information in the context knowledge base in a hypothetical manner, such that the generated information becomes in contradiction with a piece of information in the audience knowledge base, a meaning of the generated information changes or a way of the developing changes; change the generated information or change the way of developing based on the changed information in the context knowledge base, and display the changed generated information, hypothetical information, or a changed development.
